(19) United States
(12) Patent Application Publication
(10) Pub. No.: US 2025/0197204 A1
(43) Pub. Date: Jun. 19, 2025

(54) Chemical Production Inside a Well Tubular/Casing

(71) Applicant: Baker Hughes Oilfield Operations LLC, Houston, TX (US)

(72) Inventors: Sunder Ramachandran, 18844951, TX (US); Zhengwei Liu, Houston, TX (US); Jerry J. Weers, Richmond, TX (US); Jian Zou, Sugar Land, TX (US); Sandip Maity, Bangalore (IN)

(73) Assignee: Baker Hughes Oilfield Operations LLC, Houston, TX (US)

(21) Appl. No.: 18/844,951

(22) PCT Filed: Mar. 8, 2023
(86) PCT No.: PCT/US2023/014848

§ 371 Date: Sep. 7, 2024

Related U.S. Application Data
(60) Provisional application No. 63/317,893, filed on Mar. 8, 2022.

(51) Int. Cl. C01B 3/04; C01B 3/38; C01B 17/04; C01B 32/75; E21B 36/04; E21B 43/38

(52) U.S. Cl. CPC C01B 3/04; C01B 3/38; C01B 17/0495; C01B 32/75; E21B 36/04; E21B 43/38; C01B 2203/0233; C01B 2203/1241

(57) ABSTRACT

Methods for the in-situ production of one or more chemical products in a subterranean well include the steps of admitting natural gas into the well from the surrounding subterranean formation, directing the natural gas into a downhole reactor in the well, reacting the natural gas within the downhole reactor to produce an intermediate product stream that includes the one or more chemical products, and withdrawing the intermediate product stream and the one or more chemical products from the downhole reactor. The methods can be earned out in a downhole reactor (22) that includes a reaction chamber (26) inside tubing (20) and an inlet valve (24) adapted to control the introduction of natural gas into the reaction chamber (26).

### RELATED APPLICATIONS

The present application claims the benefit of U.S. Provisional Patent Application Ser. No. 63/317,893 filed Mar. 8, 2022 entitled, “Chemical Production Inside a Well Tubular/Casing,” the disclosure of which is incorporated by reference as if fully set forth herein.

### FIELD OF THE INVENTION

The present invention relates to systems and methods for manufacturing chemicals in well tubing or casing in general, and more specifically relates to the manufacture of hydrogen and other chemical products from sour gas inside a downhole reactor well in one non-limiting embodiment.

### BACKGROUND

Hydrogen sulfide (H₂S) is produced from subterranean formations in many regions of the world. Ultra-sour gas fields contain large amounts of H₂S. Hydrogen sulfide and mercaptans are toxic and corrosive substances that are naturally prevalent as impurities in petroleum products such as natural gas and crude oil. It is important to remove these substances and not introduce them into the environment. There is a large market for the manufacture and sale of H₂S scavengers to upstream operators and refineries to mitigate the production and release of H₂S in the oil and gas industry.

Different processes for H₂S removal are effective at different removal rates. Sweetening processes to remove H₂S can involve the use of chemical solvents, chemical and hybrid solvents, physical solvents, and hybrid solvents. The use of refrigeration and membranes have been involved in some processes for acid gas sweetening. The H₂S separated as part of the sweeting process can be used for industrial purposes such as sulfur production, or injected down hole for disposal away from surface environments. There is a need and corresponding market price for increased sulfur production. There is, therefore, a need for new systems and methods for mitigating the contamination of H₂S in petroleum products while capturing chemical products produced as a result of the H₂S mitigation efforts.

### SUMMARY OF THE INVENTION

In some embodiments, the present disclosure is directed to a method for the in-situ production of one or more chemical products in a well that extends into a subterranean formation that produces natural gas. The method includes the steps of admitting the natural gas into the well from the subterranean formation, directing the natural gas into a downhole reactor in the well, reacting the natural gas within the downhole reactor to produce an intermediate product stream that includes the one or more chemical products, and withdrawing the intermediate product stream and the one or more chemical products from the downhole reactor.

In some embodiments, the natural gas includes hydrogen sulfide and the step of reacting the natural gas within the downhole reactor includes heating the hydrogen sulfide within the downhole reactor to thermally decompose the hydrogen sulfide to produce chemical products that include hydrogen and sulfur. The hydrogen sulfide can be heated by a heating source selected from the group consisting of the subterranean formation, an electrical heating technique, and combinations thereof.

In some embodiments, the step of reacting the natural gas within the downhole reactor further includes the step of applying a dispersant within the downhole reactor, wherein the dispersant is selected from the group consisting of an anti-coking dispersant and a sulfur dispersant. The step of reacting the natural gas within the downhole reactor can also include the step of applying a hydrocarbon solvent within the downhole reactor.

In some embodiments, the step of reacting the natural gas within the downhole reactor includes reacting the natural gas with a catalyst inside the downhole reactor. The catalyst can be a stainless steel catalyst. The natural gas can be reacted with the stainless steel catalyst in the presence of aqueous hydrazine, monoethanol amine, sodium carbonate, or mixtures thereof.

In some embodiments, the step of reacting the hydrogen sulfide within the downhole reactor further includes activating an electrolytic cell within the downhole reactor to electrolytically decompose the hydrogen sulfide to produce chemical products that include hydrogen and sulfur.

In yet other embodiments in which the natural gas includes methane and hydrogen sulfide, the step of reacting the natural gas within the downhole reactor further includes the step of contacting the methane and hydrogen sulfide with a catalyst within the downhole reactor to oxidize the methane to produce chemical products that include hydrogen and carbon disulfide. In these embodiments, the catalyst can be selected from the group consisting of molybdenum disulfide (MoS₂), sulfided CoMo, CoMo-ZSM-5, Co-ZSM-5, Ga-ZSM-5, NiW, chromium sulfide, and combinations thereof.

In certain embodiments, the step of reacting the natural gas within the downhole reactor further includes the step of reducing pressure in the downhole reactor, which can be accomplished by connecting a compressor to the downhole reactor. The method can optionally include the step of separating the intermediate product stream into a gas product stream that includes hydrogen and a liquid product stream that includes carbon disulfide.

In yet other embodiments, the method includes the step of reacting the natural gas within the downhole reactor by contacting the methane with steam within the downhole reactor to oxidize the methane through steam reformation to produce chemical products that include hydrogen and carbon dioxide.

In another aspect, the present disclosure is directed to an in-situ downhole reactor within a subterranean well having a sour gas production zone. The in-situ downhole reactor can include a sour gas inlet adapted to receive sour gas from the subterranean formation, a regulating mechanism adapted to control the introduction of sour gas into the downhole reactor; and an intermediate product stream outlet in fluid communication with the downhole reactor. The downhole reactor optionally includes at least one catalyst, at least one mechanism for heating the sour gas inside the downhole reactor, and a capillary line for injecting one or more dispersants into the downhole reactor.

### BRIEF DESCRIPTION OF THE DRAWINGS

FIG. 1 is a schematic illustration of the method and apparatus for in-situ production of chemical products within a subterranean well;

FIG. 2 is a schematic illustration of the method and apparatus for in-situ production of chemical products within a subterranean well using thermal decomposition of hydrogen sulfide; and

FIG. 3 is a schematic illustration of the method and apparatus for in-situ production of chemical products within a subterranean well using the catalytic decomposition of hydrogen sulfide.

It will be appreciated that the Figures are rough schematics and the proportions and arrangement of components are not necessarily intended to limit the invention in any way.

### DETAILED DESCRIPTION

Hydrogen can be produced by reacting H₂S with any hydrocarbon available downhole such as methane, ethane, and propane among others. It has been discovered that H₂S can be reacted to produce hydrogen, in-situ downhole in a subterranean well. As used herein, “downhole” refers to any well location below the surface and excludes “wellhead” above the surface. “Natural gas” or “sour gas” refers to a petroleum product that includes methane and may include impurities such as hydrogen sulfide. Optionally other products besides hydrogen can be produced, including but not limited to sulfur, carbon disulfide, and carbon dioxide. Likewise, other reactants can optionally be reacted with H₂S to give optional products in addition to those listed above.

Suitable reactions that can be performed by the method and apparatus described herein include, but are not limited to, the following:
Decomposition of H₂S to hydrogen and sulfur, including catalytic, thermal and electrolytic decomposition of H₂S:

H₂S→H₂+S (Reaction 1)
Soft oxidation of methane:

CH₄+2H₂S→CS₂+4H₂ (Reaction 2)
Steam reformation of methane (also called hard oxidation of methane):

CH₄+2H₂O→CO₂+4H₂ (Reaction 3)

In one particular embodiment, hydrogen can be produced by reacting H₂S with methane (CH₄) using heat in the presence of a catalyst (Reaction 2). The reactions involved are the following:

| 2 H₂S + CH₄ → CS₂ + 4 H₂ | ΔH_{298° K} = 55.4 Kcal/mol | (Reaction |
|---|---|---|
| | | 2.1) |
| H₂S → ½ S₂ + H₂ | ΔH_{298° K} = 19.09 Kcal/mol | (Reaction |
| | | 2.2) |
| CH₄ → C + 2 H₂ | ΔH_{298° K} = 17.90 Kcal/mol | (Reaction |
| | | 2.3) |

Carbon formation can be avoided while producing carbon disulfide, sulfur and hydrogen by injecting chemicals that prevent coke formation such as dodecyl sulfonic acid or antimony pentoxide. Carbon disulfide is more valuable than sulfur as it is used to make viscose rayon and cellophane. The price for carbon disulfide varies between about $780-$1200 USD per metric tonne. This is significantly above the price of about $40 USD per metric tonne for sulfur. The process does not create CO₂.

Improvements in the Reaction 2 process can come from employing better catalysts and better separation processes. Many different transition metals may be used as catalysts in this process. High conversions to hydrogen and carbon disulfide may be accomplished using a chromium sulfide catalyst. Further work has been done using a sulfided cobalt molybdenum (CoMo) catalyst that creates carbon disulfide, other liquids, and hydrogen directly from sour gas. In general, the catalyst may be any catalyst that facilitates the reactions described herein, including but not limited to those which form transition metal sulfides under the reaction conditions, including those on solid supports.

Reaction 2 is an endothermic reaction that is catalyzed by catalysts including, but not necessarily limited to, chromium sulfide, sulfided CoMo and molybdenum sulfide (MoS₂). In one non-limiting embodiment, the reaction and catalyst work at temperatures ranging from about 900° C. independently to about 1000° C. Alternatively, temperatures can range from about 250° C. independently to about 1200° C.

For Reaction 2, the forward reaction is favored at low pressures. In another non-limiting embodiment, pressures can be between about 100 kPa independently to about 300 kPa. Pressures can alternatively range from about vacuum independently to about 50,000 kPa. As used herein with respect to a range, the term “independently” means that any given endpoint within a range may be used together with any other given endpoint within another range to provide a suitable combined range. For example ranges expressed as “A independently to B” and “C independently to D” should be interpreted as including ranges of “A to C,” “A to D,” “B to C,” “B to D.”

An in-situ downhole reactor provides optimized conditions to produce chemical products, such as hydrogen and carbon disulfide, from natural gas. The downhole reactor generally includes a remotely controlled valve that regulates the flow of natural gas into the downhole reactor. For catalyzed reactions, an upper section of the downhole reactor is filled with catalytic material which can be maintained as either a fixed or fluidized bed, in non-limiting embodiments. The upper section can be connected to a gas compressor or multiphase compressor to maintain optimized pressures for carrying out the chemical reactions promoted within the downhole reactor. The in-situ downhole reactor can also be optionally heated to maintain temperatures favorable for each reaction. In some non-limiting embodiments, the heat of the subterranean formation may be sufficient to encourage the reaction to completion. Or in some embodiments, both the formation heat and added heating may be desired. Heat may be added by electrical heating in one non-limiting embodiment.

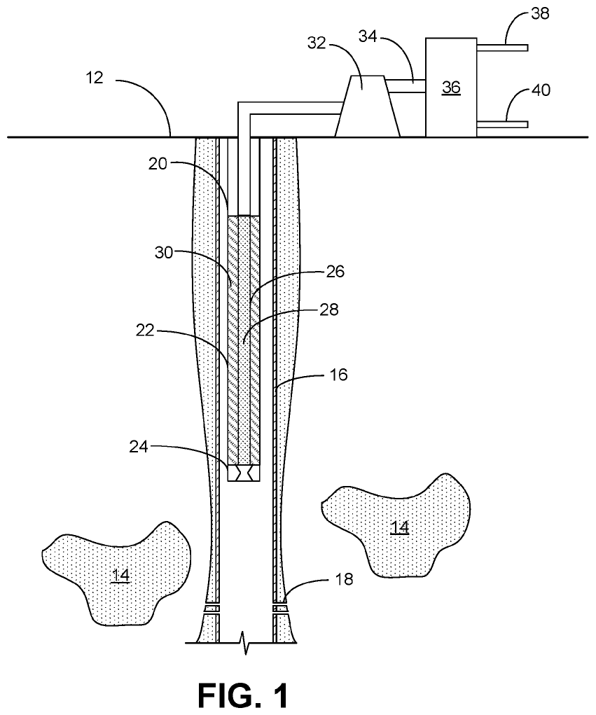

In more detail and with reference to FIG. 1, there is provided a well 10 that extends from a surface 12 to a subterranean formation 14. The surface 12 may be onshore or offshore. The formation 14 produces natural gas and potentially other petroleum hydrocarbons and brine-based fluids. The well 10 may include a casing 16 that maintains the structural integrity of the well 10. Natural gas is admitted into the well 10 through perforations 18 in the casing 16. The well 100 includes tubing 20, which extends through the casing 16 from the surface 12 to a location within the well 100. In some embodiments, the tubing 20 is production tubing that provides a path for the recovery of the natural gas from the well.

A downhole reactor 22 is located in the well 10 below the surface 12. In some embodiments, the downhole reactor 22 is positioned inside the casing 16 or the tubing 20. The downhole reactor 22 includes a remotely controlled inlet valve 24 that controls the flow of natural gas into the downhole reactor 22. The inlet valve 24 can be pneumatically, hydraulically, electrically, or mechanically actuated to any position from fully closed to fully open to block, permit and moderate the flow of natural gas into the downhole reactor 22. The inlet valve 24 can be automatically or manually controlled.

In other embodiments, the inlet valve 24 is replaced or supplemented with a porous plug or membrane that is configured to permit the flow of natural gas into the downhole reactor 22. The barrier may be similar to the calcium carbonate plug used in completion operations. Small holes may be drilled, etched, or otherwise formed or provided in the plug to create flow.

In some embodiments, the downhole reactor 22 includes a reaction chamber 26. The reactions described herein occur as the natural gas passes through the reaction chamber 26 as the natural gas is recovered from the well 10 to the surface 12. In this way, the downhole reactor 22 is primarily intended to provide a flow-through reactor, although it may be operated as a bulk reactor by intermittently closing the inlet valve 24 when the reaction chamber 26 has been sufficiently loaded with natural gas.

The reaction chamber 26 can be loaded or charged with one or more catalysts 28 that are optimized for the production of one or more selected chemicals within the downhole reactor 22. For Reaction 2, which involves the soft oxidation of methane, the catalysts 28 can include, but are not limited to, a methane dehydroaromatization catalyst comprising molybdenum disulfide (MoS₂) or sulfided CoMo, where CoMo is an alumina base impregnated with cobalt and molybdenum. Other suitable catalysts 28 include, but are not limited to, transition metal sulfides, CoMo/ZSM5 catalysts, chromium sulfide catalysts, and mixtures and combinations of catalysts including Co-ZSM-5+MoS₂, Co-ZSM-5+MoS₂, CoZSM-5+MoS₂+GaZSM-5, 2.5% Co-ZSM-5, 0.5% Co-ZSM-5, hydrocracking catalyst NiW. For Reaction 1, the catalysts 28 can include stainless steel catalysts and combinations of stainless steel catalysts with aqueous hydrazine, monoethanol amine, sodium carbonate, or mixtures thereof.

The downhole reactor 22 is optionally provided with a heating source 30 that is configured to increase the temperature of the natural gas within the downhole reactor 22. The heating source 30 can include the naturally occurring heat from the formation 14, heat from steam (whether created in-situ or injected from the surface 12), or heat from electrically powered heating elements. Suitable electrical heating sources 30 include, but are not limited to, resistive ohmic systems, inductive systems, microwave systems, laser systems, and electromagnetic systems, and combinations of these. In one non-restrictive embodiment, the heating source 30 includes a 250 W/m coiled tubing heater. In other embodiments, the natural temperature of the formation 14 may be sufficient to heat the natural gas within the downhole reactor 22 without the inclusion of the heating source 30, particularly if the well 10 is at least 3000 meters deep.

In some embodiments, the heating source 30 is placed inside the tubing 20 around the reaction chamber 26. The tubing 20 can use vacuum insulation systems that are used in some gas fields. In one non-limiting embodiment, the temperature of the downhole reactor 22 during reaction ranges from about 250° C. independently to about 1300° C.; alternatively, from about 900° C. independently to about 1000° C.

In some embodiments, the downhole reactor 22 is connected to a pressure reduction system 32 to optimize the performance of the production of chemical products in the downhole reactor 22. The pressure reduction system 32 can be a compressor that is mounted on the surface 12, with a suction line connected to the downhole reactor 22. The pressure inside the downhole reactor 22 can be selected by adjusting the operation of the compressor and the inlet valve 24.

The products from the downhole reactor 22 are discharged from the downhole reactor 22 as an intermediate product stream that may include hydrogen, carbon disulfide, carbon dioxide, sulfur and unreacted components of the natural gas, including methane. The intermediate product stream may be multiphase and include liquids and gases. The intermediate product stream can be transported by pipeline 34 to an optional separator 36. The separator 36 can be configured to separate the intermediate product stream into a gas product stream 38 and a liquid product stream 40.

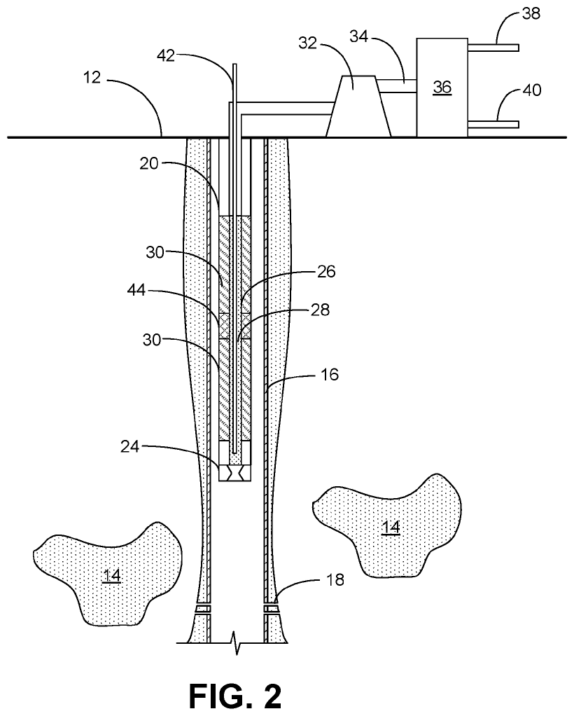

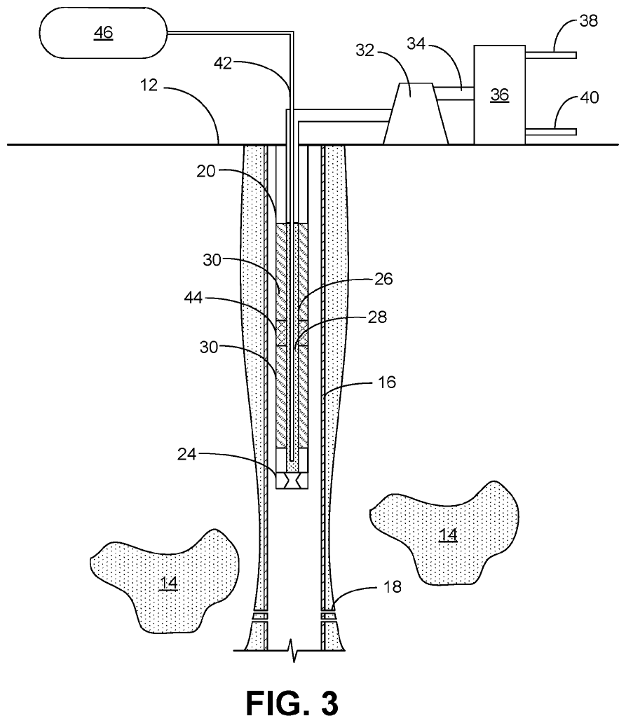

In certain other non-limiting embodiments, an additional injection line 42, such as capillary or coiled tubing, is used to provide sulfur dispersants and anti-coking additives, as shown in FIGS. 2 and 3. The injection line 42 can be used to introduce other additives to minimize or reduce fouling in the downhole reactor 22, tubing 20, casing 16, or pipeline 34, that may occur at ambient or elevated temperatures. Sulfur dispersants keep the sulfur in a liquid hydrocarbon phase to alleviate problems of sulfur extraction. Optionally, and if necessary, an appropriate hydrocarbon solvent that is thermally stable at the temperatures cited could be introduced to carry the sulfur. Some of the sulfur dispersants include, but are not limited to, polyethylene polyamines or aminoethylpiperazine or fatty amides.

In other embodiments, the downhole reactor 22 includes an electrolytic cell 44 that is configured to apply an electric current to natural gas passing through the downhole reactor 22. The electrolytic cell 44 is optimized to assist with the electrolytic decomposition of natural gas (Reaction 1) within the downhole reactor 22.

In yet other embodiments, the downhole reactor 22 is provided with a steam source 46. The steam source 46 is configured to apply steam to the downhole reactor 22, either directly into the downhole reactor 22 where it can contact the natural gas, or as a heating system around the outside of the downhole reactor 22. The steam source 22 can generate steam on the surface 12 or by pumping water into the well 10, where the steam is generated in-situ nearer to the downhole reactor 22. The steam is particularly useful in carrying out the steam reformation of methane in the downhole reactor 22 (Reaction 3).

The downhole reactor 22 thus provides a cost-effective, safe and environmentally friendly system for producing chemical products from natural gas using a variety of chemical reactions. An important advantage of conducting the reactions downhole is that it avoids the presence of hydrogen sulfide at the surface, which improves safety and lessens environmental concerns. Further, the placement of the downhole reactor 22 in the well 10 is more energy efficient because the heat required for endothermic reactions is conserved by the higher underground temperatures in the well 10.

In one mode of operation, the downhole reactor 22 is configured to carry out the decomposition of hydrogen sulfide into hydrogen and sulfur (Reaction 1). Sour gas can be admitted into the downhole reactor 22 through the inlet valve 24. The temperature of the sour gas can be increased within the downhole reactor 22 by applying heat from the heating source 30. In some embodiments, the sour gas is heated to temperatures above 700° C. to thermally decompose the hydrogen sulfide.

In another embodiment, the downhole reactor 22 carries out a catalyzed decomposition of hydrogen sulfide (Reaction 1) by incorporating the catalyst chamber 26 into the downhole reactor 22. In this embodiment, the catalyst chamber 26 includes a stainless steel catalyst 28 immersed in a mixture of 5% aqueous hydrazine, 5% monoethanol amine solutions, and sodium carbonate, which has been reported to obtain high rates of H₂S decomposition at 25° C. (see A. N Startsev, Low Temperature Catalytic Decomposition of Hydrogen into Hydrogen and Diatomic Gaseous Sulfur, Kinetics and Catalysts, 2016, 57 (4), 516-528: A. N. Startsev, O. V. Kruglyakova, Yu. A. Chesalov, E. A. Kruglyakova, Yu. A. Chesalov, E. A. Paukshtis, V. I. Avdeev, S. Ph. Ruzankin, A. A. Zhdanov. I. Yu. Molina. L. M. Plyasov, Low Temperature catalytic decomposition of hydrogen sulfide on metal catalysts under layer of solvent, Journal of Sulfur Chemistry, 2016, 37 (2), 229-240).

In yet another embodiment, the natural gas is reacted within the downhole reactor 22 by activating the electrolytic cell 44 to carry out an electrolytic decomposition of hydrogen sulfide into hydrogen and sulfur (Reaction 1). It will be appreciated that these decomposition reactions can be carried out using various combinations of heat, electrolysis and catalysts to optimize the decomposition of hydrogen sulfide into sulfur and hydrogen.

In another mode of operation, the downhole reactor 22 is configured to carry out the soft oxidation of methane (Reaction 2). In these embodiments, hydrogen is produced by reacting hydrogen sulfide with methane using heat in the downhole reactor 22 in the presence of one or more selected catalysts 28, as discussed above. The desirable chemical products of hydrogen and carbon disulfide are produced from the oxidation of methane in the presence of hydrogen sulfide. In this way, the downhole reactor 22 economically converts toxic and dangerous hydrogen sulfide into hydrogen, which can be used as an environmentally friendly fuel source, and carbon disulfide, which can be used for the production of rayon, cellophane, and dithiocarbamates. As noted above, Reaction 2 does not yield carbon dioxide as a reaction product.

In some embodiments, the pressure reduction system 32 reduces the pressure within the downhole reactor 22 to optimize the production of carbon disulfide and hydrogen. The pressure reduction system 32 can reduce the pressure within the downhole reactor 22 to a range from about vacuum or about 0.1 kPa independently to about 50,000 kPa: alternatively, from about 100 kPa independently to about 300 kPa. The pressure reduction system 32 can also assist with the removal of the intermediate product stream from the downhole reactor 22.

In other embodiments, the downhole reactor 22 is configured to maintain or adjust the temperature of the natural gas within the downhole reactor with the heating source 30. In one non-limiting embodiment, the temperature of the downhole reactor 22 during the soft oxidation of methane (Reaction 2) is selected to be within a range from about 250° C. independently to about 1300° C., or a range from about 900° C. independently to about 1000° C. to optimize the production of carbon disulfide and hydrogen. It will be appreciated that the downhole reactor 22 may carry out the methane oxidation reactions (Reaction 2) using various combinations of catalysts, temperatures and pressures to optimize the production of carbon disulfide and hydrogen from methane and hydrogen sulfide.

In yet another mode of operation, the downhole reactor 22 is configured to carry out the steam reformation of methane (Reaction 3) by contacting the natural gas inside the downhole reactor 22 with steam provided by the steam source 46. In these embodiments, the steam reformation process yields hydrogen and carbon dioxide from methane and steam.

In the foregoing specification, the various embodiments have been described with reference to specific embodiments thereof, and has been described as effective in providing systems and methods for the in-situ production of H₂ and CS₂ using the downhole reactor 22. It will be evident, however, that various modifications and changes can be made thereto without departing from the broader scope of these embodiments. Accordingly, the specification is to be regarded in an illustrative rather than a restrictive sense. For example, specific reactants, catalysts, products, proportions, reaction conditions, capillary strings, tubing, and other components and procedures falling within the claimed parameters, but not specifically identified or tried in a particular method or composition, are expected to be within the scope of the contemplated embodiments.

The presently disclosed embodiments may suitably comprise, consist, or consist essentially of the elements disclosed and may be practiced in the absence of an element not disclosed. For instance, there may be provided a method for in-situ production of hydrogen comprising, consisting essentially of, or consisting of controlling sour gas introduction from a subterranean sour gas production zone into an in-situ, tubular downhole reactor comprising at least one catalyst, where the downhole reactor is placed within or near the sour gas production zone of a subterranean well; reacting the H₂S in the sour gas in the downhole reactor to produce an intermediate product stream comprising at least hydrogen; and withdrawing an intermediate product stream from the downhole reactor. In one non-limiting embodiment, the intermediate product stream comprises the carbon disulfide and hydrogen. In a different non-restrictive version, the in-situ downhole reactor is heated. Alternatively, pressure in the in-situ downhole reactor may be optionally reduced. In another non-limiting embodiment, dispersants may be introduced into the in-situ downhole reactor through an optional capillary string or other mechanism.

In another non-restrictive version, there is provided an in-situ downhole reactor within a subterranean well having a sour gas production zone comprising, consisting essentially of, or consisting of a sour gas inlet adapted to receive sour gas from the subterranean sour gas production zone, a regulating mechanism adapted to control the introduction of sour gas into the tubular downhole reactor, and an intermediate product stream outlet. Optionally, the in-situ tubular downhole reactor is partially or completely filled with at least one catalyst. In another non-limiting embodiment, the in-situ tubular downhole reactor contains a heater, which optionally may be an electrical heater. In another optional embodiment, the in-situ tubular downhole reactor is in fluid communication with a compressor adapted to reduce pressure in the reactor. Further, in another non-restrictive version, the in-situ tubular downhole reactor may comprise an electrochemical cell. And in another non-limiting embodiment, the in-situ tubular downhole reactor may comprise a capillary string adapted for the introduction of a dispersant.

The words “comprising” and “comprises” as used throughout, are to be interpreted to mean “including but not limited to” and “includes but not limited to”, respectively.

As used herein, the singular forms “a,” “an,” and “the” are intended to include the plural forms as well, unless the context clearly indicates otherwise. As used herein, the term “about” in reference to a given parameter is inclusive of the stated value and has the meaning dictated by the context (e.g., it includes the degree of error associated with measurement of the given parameter). As used herein, the term “and/or” includes any and all combinations of one or more of the associated listed items.

1. A method for the in-situ production of one or more chemical products in a well that extends into a subterranean formation that produces natural gas, the method comprising the steps of:
admitting the natural gas into the well from the subterranean formation;
directing the natural gas into a downhole reactor in the well;
reacting the natural gas within the downhole reactor to produce an intermediate product stream that includes the one or more chemical products; and
withdrawing the intermediate product stream and the one or more chemical products from the downhole reactor.

2. The method of claim 1, wherein the natural gas includes hydrogen sulfide and the step of reacting the natural gas within the downhole reactor further comprises heating the hydrogen sulfide within the downhole reactor to thermally decompose the hydrogen sulfide to produce the one or more chemical products that include hydrogen and sulfur.

3. The method of claim 2, wherein the step of heating the hydrogen sulfide within the downhole reactor to thermally decompose the hydrogen sulfide further comprises heating the hydrogen sulfide from a source selected from the group consisting of the subterranean formation, an electrical heating technique, and combinations thereof.

4. The method of claim 2, wherein the step of reacting the natural gas within the downhole reactor further comprises applying a dispersant within the downhole reactor, wherein the dispersant is selected from the group consisting of an anti-coking dispersant and a sulfur dispersant.

5. The method of claim 3, wherein the step of reacting the natural gas within the downhole reactor further comprises applying a hydrocarbon solvent within the downhole reactor.

6. The method of claim 2, wherein the step of reacting the natural gas within the downhole reactor further comprises reacting the natural gas with a catalyst inside the downhole reactor.

7. The method of claim 6, wherein the step of reacting the natural gas within the downhole reactor further comprises reacting the natural gas with a stainless steel catalyst inside the downhole reactor in the presence of aqueous hydrazine, monoethanol amine, sodium carbonate, or mixtures thereof.

8. The method of claim 1, wherein the natural gas includes hydrogen sulfide and the step of reacting the hydrogen sulfide within the downhole reactor further comprises activating an electrolytic cell within the downhole reactor to electrolytically decompose the hydrogen sulfide to produce the one or more chemical products that include hydrogen and sulfur.

9. The method of claim 1, wherein the natural gas includes methane and hydrogen sulfide and the step of reacting the natural gas within the downhole reactor further comprises the step of contacting the methane and hydrogen sulfide with a catalyst within the downhole reactor to oxidize the methane to produce the one or more chemical products that include hydrogen and carbon disulfide.

10. The method of claim 9, wherein the step of contacting the methane and hydrogen sulfide with a catalyst further comprises contacting the methane and hydrogen sulfide with a catalyst within the downhole reactor, wherein the catalyst is selected from the group consisting of molybdenum disulfide (MoS₂), sulfided CoMo, CoMo-ZSM-5, Co-ZSM-5, Ga-ZSM-5, NiW, chromium sulfide, and combinations thereof.

11. The method of claim 9, wherein the step of reacting the natural gas within the downhole reactor further comprises the step of reducing pressure in the downhole reactor.

12. The method of claim 9 further comprises the step of separating the intermediate product stream into a gas product stream that includes the hydrogen and a liquid product stream that includes the carbon disulfide.

13. The method of claim 1, wherein the natural gas includes methane and the step of reacting the natural gas within the downhole reactor further comprises the step of contacting the methane with steam within the downhole reactor to oxidize the methane through steam reformation to produce chemical products that include hydrogen and carbon dioxide.

14. An in-situ downhole reactor within a subterranean well extending into a formation that produces natural gas, wherein the well includes tubing that extends to a surface, the downhole reactor comprising:
a reaction chamber inside the tubing; and
an inlet valve adapted to control the introduction of natural gas into the reaction chamber.

15. The in-situ tubular downhole reactor of claim 14, further comprising:
at least one catalyst in the reaction chamber;
a heating source for heating the natural gas inside the downhole reactor; and
an injection line for injecting one or more dispersants into the downhole reactor.

16. The in-situ tubular downhole reactor of claim 15, wherein the at least one catalyst is selected from the group consisting of molybdenum disulfide (MoS₂), sulfided CoMo, CoMo-ZSM-5, Co-ZSM-5, Ga-ZSM-5, NiW, chromium sulfide, stainless steel, and combinations thereof, wherein the one or more dispersants is selected from the group consisting of anti-coking dispersants and sulfur dispersants.

17. The in-situ tubular downhole reactor of claim 15, wherein the heating source is positioned around the reaction chamber inside of the tubing.

18. The in-situ tubular downhole reactor of claim 15, further comprising an electrolytic cell for applying an electric current to the natural gas inside the downhole reactor.

19. The in-situ downhole reactor of claim 15, further configured to contact the natural gas with steam generated by a steam source.

20. The in-situ downhole reactor of claim 15, wherein pressure in the in-situ downhole reactor is from about 0.1 kPa to about 300 kPa.
